(19) United States
(12) Patent Application Publication
(10) Pub. No.: US 2026/0059350 A1
(43) Pub. Date: Feb. 26, 2026

(54) METHOD AND SYSTEMS TO DETECT NETWORK COMPONENTS IN NETWORKS

(71) Applicant: Charter Communications Operating, LLC, St. Louis, MO (US)

(72) Inventors: Jay Liew, Parker, CO (US); Roger Stafford, Thornton, CO (US)

(21) Appl. No.: 18/814,416

(22) Filed: Aug. 23, 2024

(51) Int. Cl. H04W 24/02

(52) U.S. Cl. CPC H04W 24/02

(57) ABSTRACT

Obtaining data from a plurality of first network components in a network. The data includes at least one detectable signature characterizing presence of at least one second network component that is incompatible with a modification of the network. Classify the obtained data to identify the at least one detectable signature. Identify the at least one second network component implicated by the classification results. Facilitate mitigation of the at least one second network component.

### FIELD OF THE INVENTION

The present invention relates generally to the electrical, electronic, and computer arts, and, more particularly, to electronic devices, networking, and network management.

### BACKGROUND OF THE INVENTION

In a network, such as a cable or hybrid-fiber cable (HFC) network, filters, amplifiers, and/or other network components originally installed for the provisioning of an existing service can become an impediment to the installation and provisioning of new services. An example is an in-home amplifier or multimedia over cable (MoCA) point-of-entry filter that was part of a legacy system installation, but which is no longer required for new services and, in certain cases, can prevent the provisioning and proper operation of a new service, such as a high-split upgrade. Another example of legacy system components is the existing use of low-split diplexers (5-42 MHz). These become an impediment to new services that use a high-split configuration (5-204 MHz), or at higher frequency split values in the future. These migration options are part of the DOCSIS 3.1 and 4.0 standards.

### SUMMARY OF THE INVENTION

Principles of the invention provide methods and systems to detect network components in networks. In one aspect, an exemplary method includes the steps of obtaining data from a plurality of first network components in a network, the data including at least one detectable signature characterizing presence of at least one second network component that is incompatible with a modification of the network; classifying the obtained data to identify the at least one detectable signature; identifying the at least one second network component implicated by the classification results; and facilitating mitigation of the at least one second network component.

In another aspect, a non-transitory computer readable medium includes computer executable instructions which when executed by a computer cause the computer to perform the method of obtaining data from a plurality of first network components in a network, the data including at least one detectable signature characterizing presence of at least one second network component that is incompatible with a modification of the network; classifying the obtained data to identify the at least one detectable signature; identifying the at least one second network component implicated by the classification results; and facilitating mitigation of the at least one second network component.

In still another aspect, an exemplary apparatus includes a memory, and at least one processor, coupled to the memory, and operative to: obtain data from a plurality of first network components in a network, the data including at least one detectable signature characterizing presence of at least one second network component that is incompatible with a modification of the network; classify the obtained data to identify the at least one detectable signature; identify the at least one second network component implicated by the classification results; and facilitate mitigation of the at least one second network component.

In a further aspect, another exemplary apparatus includes: a cable network with a plurality of first network components and at least one second network component that is incompatible with a modification of the network; a data collector component in the cable network; a machine learning engine; and a rules-based analyzer. The data collector is configured to obtain data from the plurality of first network components in the network, the data including at least one detectable signature characterizing presence of the at least one second network component. The machine learning engine is configured to classify the obtained data to identify the at least one detectable signature. The rules-based analyzer is configured to identify the at least one second network component implicated by the classification results.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a non-transitory machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps (or a system wherein one or more such apparatuses are networked together, optionally with one or more other components). Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
detection of legacy network components, such as filters and amplifiers, in a cable network infrastructure;
mitigation of legacy network components that impair or prevent the deployment of new services on a cable network infrastructure; and
machine learning systems for automatically classifying signatures derived from network telemetry information on a cable network infrastructure. Furthermore, while the classification of channels within a network device, such as the cable modem, is pertinent, the severity of the classification is also important. An example would be extending spectrum from 1.0 to 1.2 GHz where certain network components may or may not perform depending on the extent of the impairment. A non-limiting example is a tap rated for 1 GHz, which may be able to support more capacity above 1 GHz, compared to another that is farther away from the fiber node, such as further south in the amplifier cascade.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a functional block diagram illustrating an exemplary FTTH system, which is one exemplary system within which one or more embodiments could be employed;

FIG. 9 is a functional block diagram of an exemplary centralized S-ONU CPE unit interfacing with the system of FIG. 8;

FIGS. 10A and 10B are a high-level diagram of a legacy architecture for a low-split cable network;

FIG. 11 is a block diagram of a network plant configured to detect and mitigate network components that impair the utilization of upstream channels in a cable network, in accordance with example embodiments;

FIG. 12 is a sequence diagram for detecting and mitigating network components (e.g., that impair the utilization of upstream channels in a cable network), in accordance with example embodiments;

FIG. 13 is an example signal waveform for an impaired cable modem; and

FIG. 14 is an example graph showing the relationship of a modulation error ratio (MER) value and standard deviation of the MER value for each of a plurality of cable modems, in accordance with an example embodiment.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Principles of the present disclosure will be described herein in the context of apparatus, systems, and methods for electronic devices, networking and network management. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

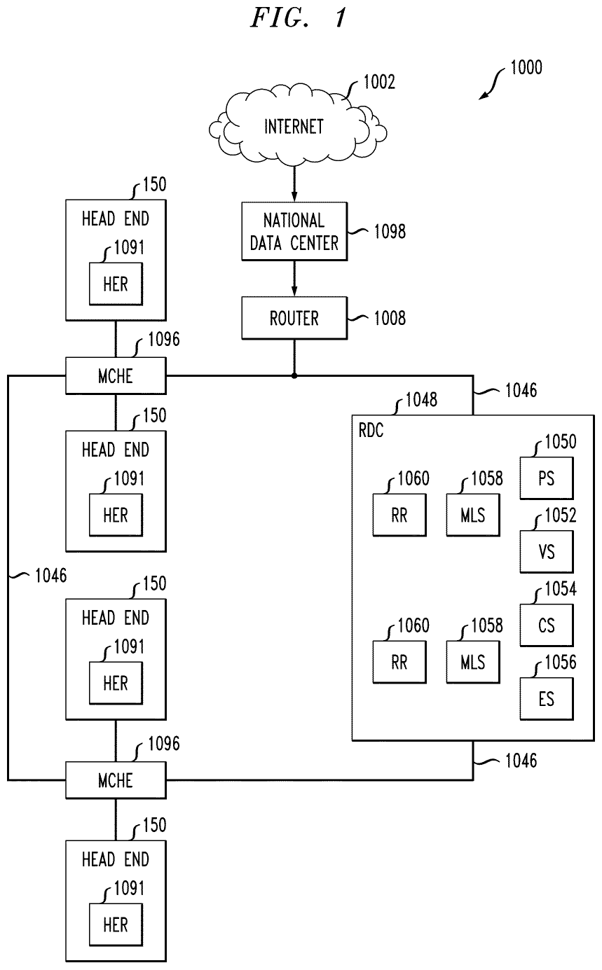

Certain aspects of cable and fiber systems, which are examples of a context in which aspects of the invention can be employed, will now be discussed; the skilled artisan will be familiar with current versions of/analogs to “classic” components discussed herein. FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers (ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

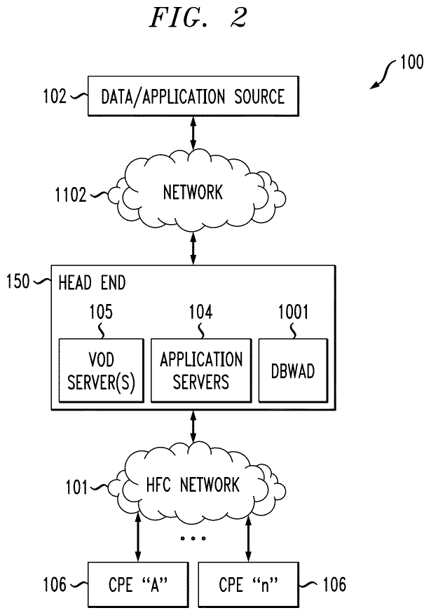

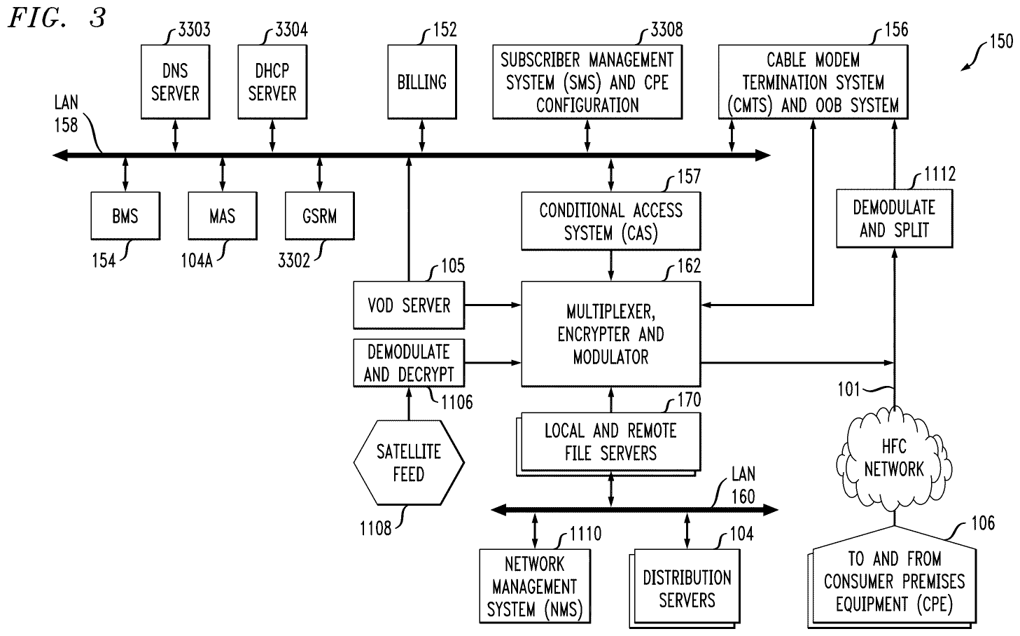

FIG. 2 is a functional block diagram illustrating an exemplary content-based (e.g., hybrid fiber-coaxial (HFC)) divisional network configuration, useful within the system of FIG. 1. See, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE). The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

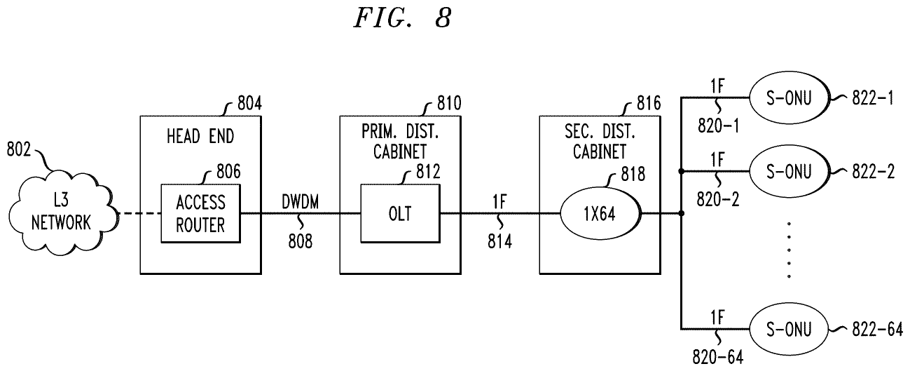

The CPE 106 includes any equipment in the “customers' premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses. Reference is also made to the discussion of an exemplary FTTH network in connection with FIGS. 8 and 9.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

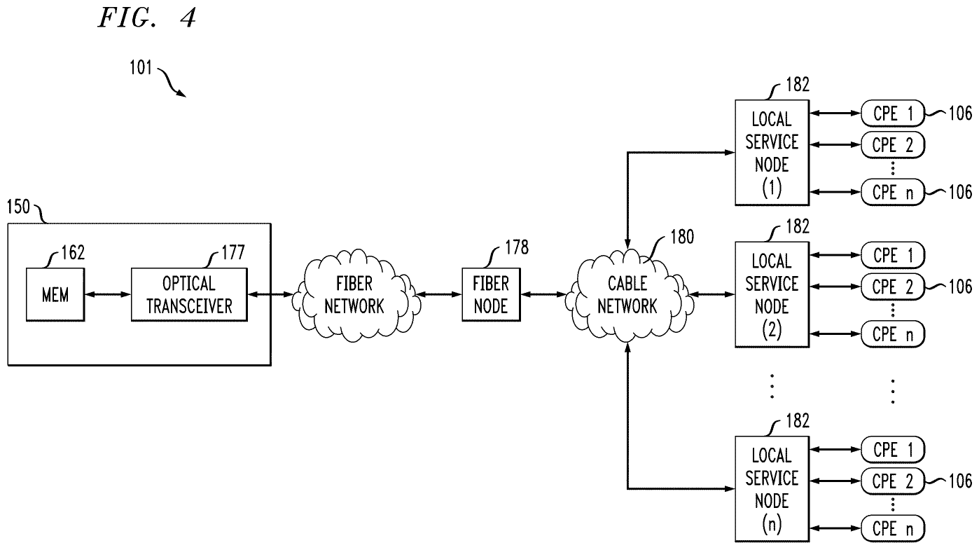

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.32 Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television Laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention”—it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

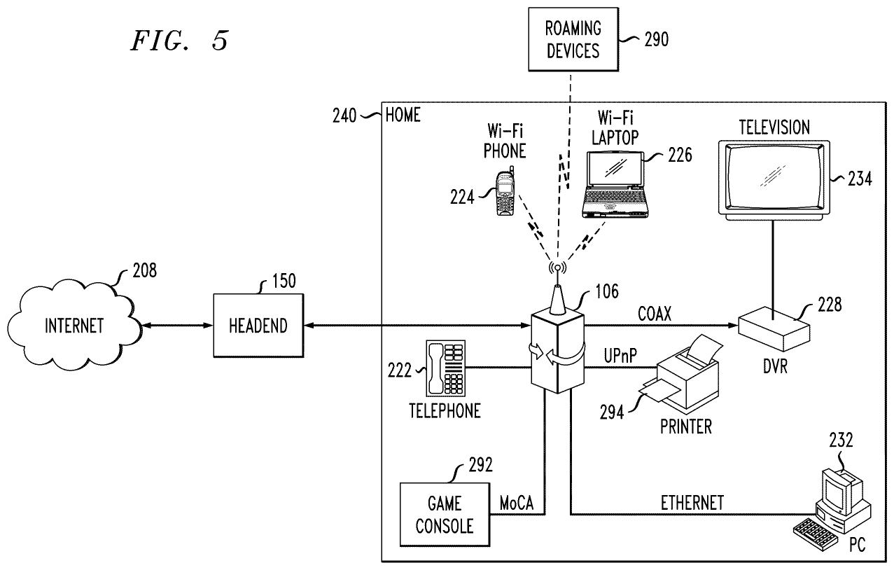

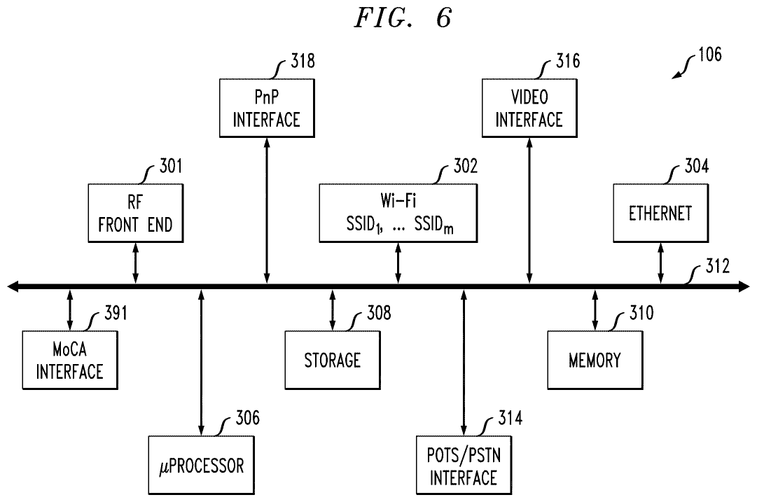

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like. The CPE can also be a Service Optical Network Unit (S-ONU) for FTTH deployment-see FIGS. 8 and 9 and accompanying text.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VOIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VOIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as for example packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

As noted, there are also fiber networks for fiber to the home (FTTH) deployments (also known as fiber to the premises or FTTP), where the CPE is a Service ONU (S-ONU; ONU=optical network unit). Referring now to FIG. 8, L3 network 802 generally represents the elements in FIG. 1 upstream of the head ends 150, while head end 804, including access router 806, is an alternative form of head end that can be used in lieu of or in addition to head ends 150 in one or more embodiments. Head end 804 is suitable for FTTH implementations. Access router 806 of head end 804 is coupled to optical line terminal 812 in primary distribution cabinet 810 via dense wavelength division multiplexing (DWDM) network 808. Single fiber coupling 814 is then provided to a 1:64 splitter 818 in secondary distribution cabinet 816 which provides a 64:1 expansion to sixty-four S-ONUs 822-1 through 822-64 (in multiple premises) via sixty-four single fibers 820-1 through 820-64, it being understood that a different ratio splitter could be used in other embodiments and/or that not all of the 64 (or other number of) outlet ports are necessarily connected to an S-ONU.

Giving attention now to FIG. 9, wherein elements similar to those in FIG. 8 have been given the same reference number, access router 806 is provided with multiple ten-Gigabit Ethernet ports 999 and is coupled to OLT 812 via L3 (layer 3) link aggregation group (LAG) 997. OLT 812 can include an L3 IP block for data and video, and another L3 IP block for voice, for example. In a non-limiting example, S-ONU 822 includes a 10 Gbps bi-directional optical subassembly (BOSA) on-board transceiver 993 with a 10G connection to system-on-chip (SoC) 991. SoC 991 is coupled to a 10 Gigabit Ethernet RJ45 port 979, to which a high-speed data gateway 977 with Wi-Fi capability is connected via category 5E cable. Gateway 977 is coupled to one or more set-top boxes 975 via category 5e, and effectively serves as a wide area network (WAN) to local area network (LAN) gateway. Wireless and/or wired connections can be provided to devices such as laptops 971, televisions 973, and the like, in a known manner. Appropriate telephonic capability can be provided. In a non-limiting example, residential customers are provided with an internal integrated voice gateway (I-ATA or internal analog telephone adapter) 983 coupled to SoC 991, with two RJ11 voice ports 981 to which up to two analog telephones 969 can be connected. Furthermore, in a non-limiting example, business customers are further provided with a 1 Gigabit Ethernet RJ45 port 989 coupled to SoC 991, to which switch 987 is coupled via Category 5e cable. Switch 987 provides connectivity for a desired number n (typically more than two) of analog telephones 967-1 through 967-n, suitable for the needs of the business, via external analog telephone adapters (ATAs) 985-1 through 985-n. The parameter “n” in FIG. 9 is not necessarily the same as the parameter “n” in other figures, but rather generally represents a desired number of units. Connection 995 can be, for example, via SMF (single-mode optical fiber).

In addition to “broadcast” content (e.g., video programming), the systems of FIGS. 1-6, 8, and 9 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve. Furthermore, one or more embodiments could be adapted to situations where a cable/fiber broadband operator provides wired broad band data connectivity but does not provide QAM-based broadcast video.

Further regarding FIGS. 8 and 9, it is worth noting that currently, typical fiber systems do not use multiple modulation schemes. However, in the future, fiber could use multiple modulation schemes to extend the bandwidth; in such cases, aspects of the invention can be employed.

Generally, techniques are provided for locating and identifying network components, such as filters, amplifiers, and the like, on networks such as cable networks (of which HFC networks are a subset) and the like. Example embodiments enable personnel at cable companies to accurately locate network components in a cable plant; for example, before, during, or after a system upgrade process.

The use of orthogonal frequency-division multiple access (OFDMA) and orthogonal frequency-division multiple (OFDM) channels within a DOCSIS 3.1 system has opened up new possibilities for the detection of impairments in a plant infrastructure. Since OFDMA upstream channels (with a bandwidth of up to, for example, 96 MHz) and OFDM downstream channels (with a bandwidth of up to, for example, 192 MHz) include thousands of individual sub-carriers spaced 25 kHz or 50 kHz apart, the ability to accurately detect certain signal patterns has now become available for networking debugging purposes. This is so because of the high granularity of the signal quality (through subcarriers) across the channel, and by analyzing the subcarriers as a whole, it is possible to determine the exact location of the spectrum affected, and how the spectrum is affected. Furthermore, if spectrum is extended, the equipment in the plant, depending on certain factors, such as the distance between equipment in relation to the fiber node, may impact the quality of service for a customer. This determines where and how it is desired to perform such network upgrades.

Prior to DOCSIS 3.1 and 4.0, it was not possible to obtain anything other than up to a four DOCSIS channels (6.4 MHz wide) single value for Signal-to-Noise Ratio (SNR), which means resolution was very low (similarly for the downstream 32 DOCSIS 3.0 channels each with a width of 6.0 MHz, which is a limited spectrum and resolution). OFDMA and OFDM make use of thousands of 25 kHz or 50 kHz sub-carriers (to carry data) and an MER (modulation error ratio) value (analogous to SNR) is available for every sub-carrier within a much wider channel, up to n×96 MHz for OFDMA upstream and m×192 MHz for OFDMA downstream. Thus, one or more embodiments have the ability to detect spectral impediments at up to 25 kHz resolution across much wider spectral bandwidths. The parameters n and m are, respectively, the number of upstream channels and the number of downstream channels. It has become standard within cable providers to make use of received modulation error ratio (RxMER) measurements to identify impairments, such as interference from frequency modulated (FM) radio stations and cellular long-term evolution (LTE) transmissions, because each of these interference types causes a reduction in the RxMER of at least one subcarrier.

Using RxMER data, it is possible to detect certain digital signatures, or patterns, in the RxMER or sub-carrier data, because network components, such as filters and diplexers, attenuate a group or band of sub-carriers at specific frequencies or specific ranges of frequencies. In one or more embodiments, “impairments” include roll-off regions or band-stop regions caused by now unwanted amplifiers, diplexers, signal splitters, MoCA filters, specific service blocking filters such as frequency blockers that block a small (usually 6 MHz) part of the downstream spectrum to prevent receipt of a particular channel by non-subscribers, and the like.

For example, a multimedia over cable (MoCA) point-of-entry filter will block all signals and sub-carriers in the downstream path from 1,010 MHz upwards. Similarly, an in-home amplifier will block all sub-carriers in the upstream path from 50 MHz upwards. Both of these components will generate an identifiable signature on the cable, which can be easily recognized by both humans looking at RxMER graphs, or by machines using pattern recognition techniques. By interrogating the customers' modems and requesting RxMER files, either a machine-learning model or a human observer can remotely detect filters and other types of network components in such a manner, and identify their type on a per service customer basis. This point is pertinent to one or more embodiments, because detection using the “by sub-carrier method” allows either: (i) individual customer modems/service to be detected remotely, whereas previous methods have relied on a service technician to visit the home and inspect the wiring configuration in the case of blocking/MoCA filters or inspect the taps for groups of 1-8 homes, in the case of a tap roll-off, or (ii) a large group south of an amplifier with a roll-off limitation. A method according to one or more embodiments can also be used to detect reductions in signal level (via MER values) due to splitters (in the passband region).

### High-Split Enabled Plant

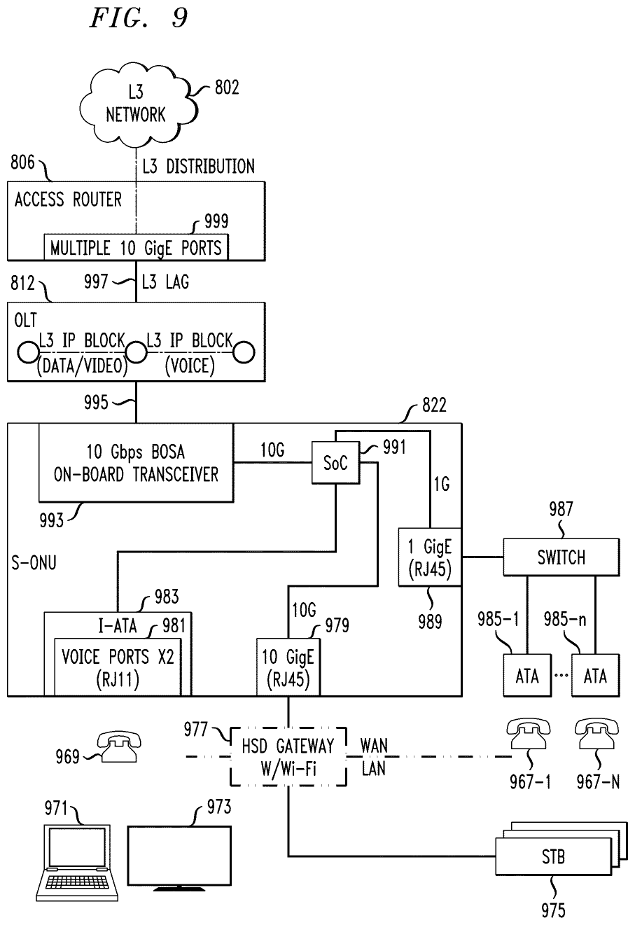

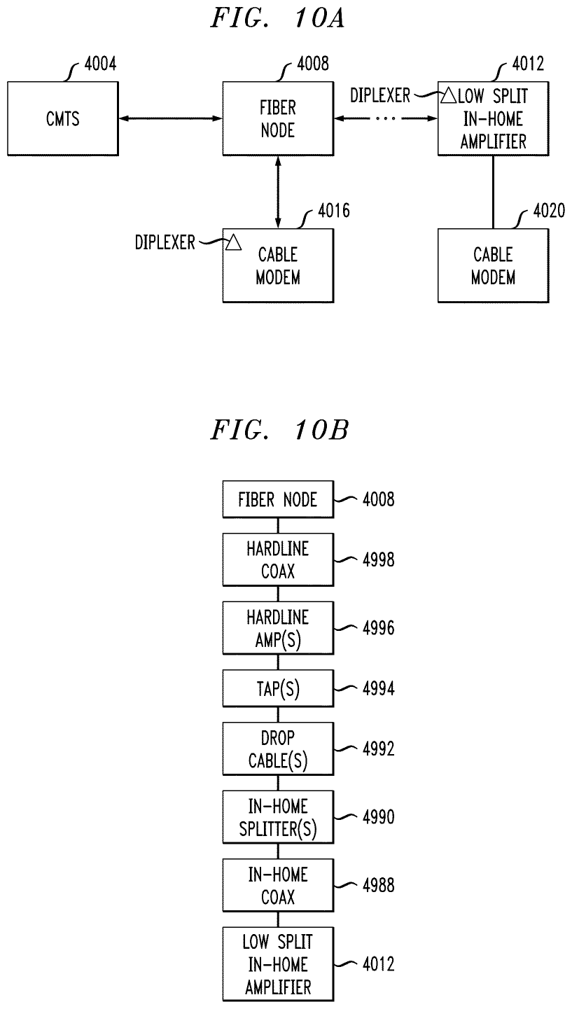

FIGS. 10A and 10B are a high-level diagram of a legacy architecture for a low-split cable network. Note the cable modem termination system (CMTS) 4004, fiber node 4008, cable modem 4016 with a diplexer, and cable modem 4020 connected to the fiber node 4008 through low split in-home amplifier 4012 with a diplexer. As indicated by the ellipsis in FIG. 10A, and referring to FIG. 10B, other components typically exist in the cable network between blocks 4008 and 4012; for example, a block for each of hardline coaxial cable 4998, hardline amplifiers 4996, taps 4994, drop-cables 4992, in-home splitters 4990, and in-home coaxial cables 4988. These elements are often referred to as a “cascade.” See also FIG. 4 which shows cable network 180 downstream of fiber node 178. Cable modems 4016, 4020 are generally representative of, for example, up to 200-250 cable modems in a service group or the like. The low-split configuration utilizes the 5-42 MHz spectrum on the return path (upstream); a guard region is present from 42-52 MHz, and from 52 MHz up is downstream traffic. A high-split configuration (designed to increase upstream capacity), alternatively, utilizes 5-204 MHz spectrum on the return path; a guard band is present from 204-258 MHz, and from 267 MHz up is downstream (e.g., video) traffic. Note that 204-258 MHz is the DOCSIS 3.1 and 4.0 high-split guard band; in one or more embodiments the guard band can be 20% of available capacity. Due to the existence of the diplexer in the cable modem 4016, the legacy system is not capable of supporting the full bandwidth of a high-split configuration (5-204 MHz). Thus, there will be unusable OFDMA channels when implementing a high-split configuration on such a legacy system, since some network components that function in the low-split configuration are incompatible with the high-split configuration. One or more embodiments use telemetry to identify such network components, so they can be removed to permit upgrading to a high-split configuration.

In the non-limiting example of FIG. 10A, to increase the upstream capacity in the legacy system, the cable modem 4016 with the diplexer and the in-home amplifier 4012 with the diplexer inside the amplifier housing need to be removed; this is typically true for the hardline coaxial amplifiers 4998 and the in-home amplifiers, despite them servicing different amplifier functions. Moreover, while low-split amplifiers 4012 are used in low-split plants to increase the signal strength in the home, such amplifiers 4012 will not work in high-split plants (they use the 5-42 MHz spectrum on the return path). Thus, any low-split, in-home amplifier 4012 would need to be removed. To summarize, then, in one aspect, the cable modem 4016 will need to be replaced, and the low split amplifier 4012 will need to be removed. Generally, any main hardline amplifiers will need to be replaced with high-split amplifiers after their presence and location has been determined. For low-split in-home amplifiers, their presence and location needs to be determined, but these are typically removed not replaced because most cable companies do not want to use in-home amplifiers in the future. Instead, the system signal levels are being increased to each home so in-home amplifiers are no longer required.

Other equipment, such as splitters, would exhibit different behavior on the network. Splitters are an equipment item of interest to one or more embodiments. Splitters also contain bandpass and bandstop filters that can prevent spectrum usage for future upgrades. Furthermore, splitters also lower the signal in its intended region of passband, which reduces the MER to devices south of it, such as modems. Thus, it is appropriate in at least some instances to identify unwanted signal level conditions through this MER per subcarrier detection method, in addition to the spectrum limiting cases. In order to remove or replace network components that impair the ability to utilize the full high-split bandwidth, these components need to be identified and located on the network.

In FIGS. 10A and 10B, CMTS 4004 is analogous, for example, to CMTS 156 in FIG. 3; fiber node 4008 is analogous to fiber node 178 in FIG. 4; and cable modems 4016, 4020 are analogous to the cable modems in CPE 106 in FIGS. 2, 3, and 5.

### Network Component Detection

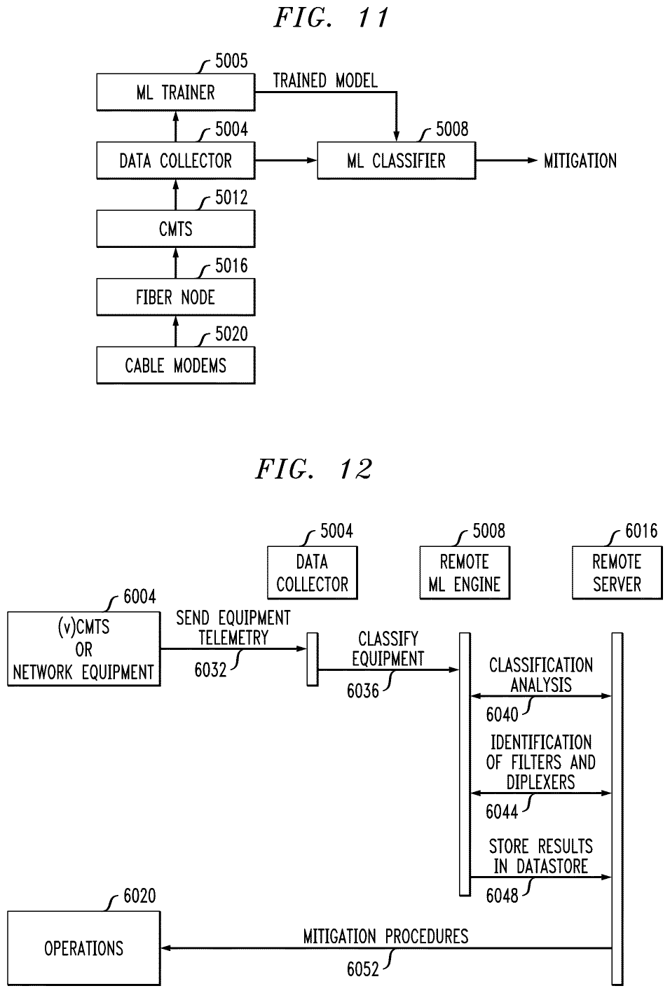

FIG. 11 is a block diagram of a network plant configured to detect and mitigate network components that impair the utilization of upstream channels in a cable network, in accordance with example embodiments. In FIG. 11, CMTS 5012 is analogous, for example, to CMTS 156 in FIG. 3; fiber node 5016 is analogous to fiber node 178 in FIG. 4; and cable modems 5020 are analogous to the cable modems in CPE 106 in FIGS. 2, 3, and 5. As illustrated in FIG. 11, a service group is monitored and network components that impair the utilization of the upstream channels are detected. In the context of high split, monitoring should typically be carried out across the service groups. In the case of an amplifier in the home, it is typically appropriate to mitigate the issue inside of the home. In the case of taps outside of the home, it is typically appropriate to monitor from a cable plant service group perspective.

A data collector 5004 collects telemetry information from network components, such as the CMTS 5012, cable modems 5020 and other equipment in the plant. For example, telemetry information for the cable modems 5020 can be obtained by the data collector 5004 interconnected via a fiber node 5016. The telemetry information, such as an RxMER reading, can be used to generate a signature of the signal. The signature can be generated by the data collector 5004 or another entity (such as the host (e.g., server 6016) of the ML classifier 5008). The machine learning (ML) classifier 5008, such as a neural network, classifies the equipment (e.g., cable modems 5020) based on the signatures obtained from the data collector 5004. The signature can be generated by the data collector 5004, the host of the ML classifier 5008, or another entity.

In one or more embodiments, the signature is present in the RxMER data. The RxMER data is representative of a channel for a cable modem. A cable modem in high split plants typically includes two OFDMAs and one OFDM channel. In one or more embodiments, a data collector carries out the processing of the raw data, which is part of the DOCSIS standards. Given the teachings herein, the skilled artisan can construct a suitable data collector by adapting known techniques such as polling devices with simple network management protocol (SNMP) or the like. This data is stored in databases for consumption for various groups; in some instances, using a machine learning (ML) algorithm to replace the human element. A post-processing feature can be used in some instances to examine the content of RxMER files, looking for certain signatures in the data. In one or more embodiments, it is possible to combine this information with other data beyond what is in RxMER files to obtain greater recognition of issues; for example, using ML.

The ML classifier 5008 (also referred to as a remote ML engine herein) can, for example, label the cable modem 5020 as impairing or supporting the full utilization of the upstream channels of a high-split plant. Similarly, the ML classifier 5008 can classify the monitored signal as suffering from interference from frequency modulated (FM) radio stations, interference from cellular long-term evolution (LTE) transmissions, filtering by a particular type of filter, and the like. Other common but non-limiting examples of interference include amateur radio operations, mobile and fixed very high frequency (VHF) communications, switched-mode power supply noise coming from within homes, and the like. Mitigation can then be effectuated.

### Sequence Diagram

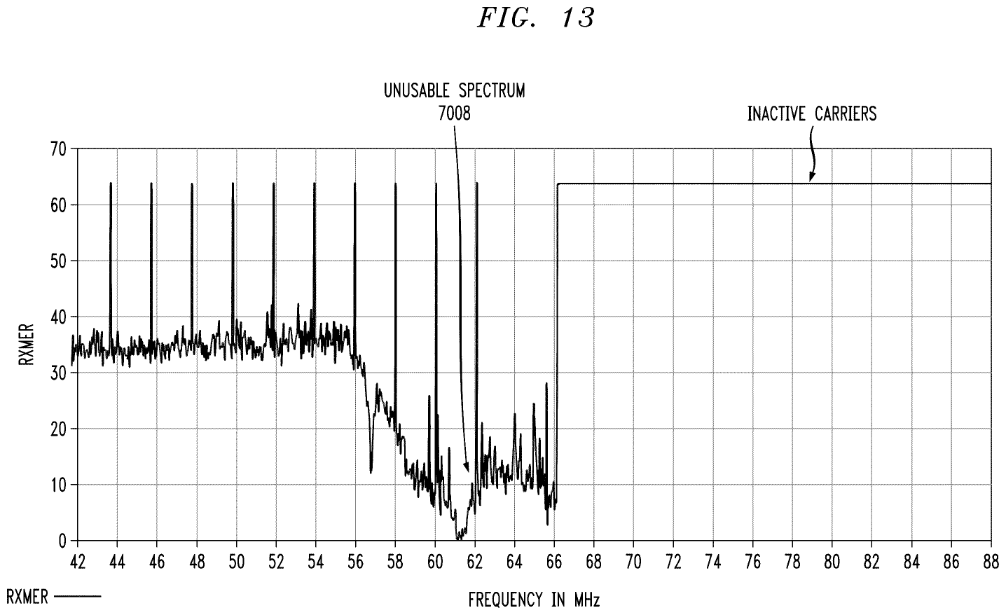

FIG. 12 is a sequence diagram for detecting and mitigating problematic network components (e.g., those that impair the utilization of upstream channels in a cable network or the like), in accordance with an exemplary embodiment. Note, however, that aspects of the invention also apply to the downstream path. For example, the legacy application of 1 GHz amplifiers and taps can be extended from 1.0 to 1.2 GHz in many cases (that is to say, a nominal 1.0 GHz amplifier may in fact be usable up to 1.2 GHz using aspects of the invention and/or the DOCSIS 3.1 Profile Management Application (PMA)). The skilled artisan will be familiar with PMA from, for example, DOCSIS 3.1 Profile Management Application Technical Report, CM-TR-PMA-V01-180530, Cable Television Laboratories, Inc. May 30, 2018, hereby expressly incorporated herein by reference in its entirety for all purposes. In the example of FIG. 12, a legacy physical CMTS or virtual CMTS (v-CMTS) 6004 sends equipment telemetry information, such as a receive modulation error ratio (RxMER) reading, to the data collector 5004 (step 6032). In one or more exemplary embodiments, the receive modulation error ratio (RxMER) reading characterizes a channel of a corresponding cable modem 4020, 5020. The elements in FIG. 12 are located upstream of CMTS 6004. One or more embodiments can be employed with both legacy CMTS and v-CMTS such as in a Distributed Access Architecture (DAA) deployment.

In legacy systems, for example, the data collector 5004 can be implemented as a simple network management protocol (SNMP) collector that polls the CMTS 6004. The CMTS 6004 responds to collector 5004 with the query results and the collector aggregates the data. In systems utilizing a v-CMTS, for example, a streaming telemetry paradigm can be utilized. Instead of polling, the v-CMTS 6004 sends the data from time to time, based, for example, on the frequency of events on the network. Types of events can include RxMER, FEC (forward error correction), network topology, cable modem status, signal level, modem resets, partial service state flags, and the like. In either scenario, the data collector 5004 processes and aggregates the data, and stores it in a database (e.g., on server 6016).

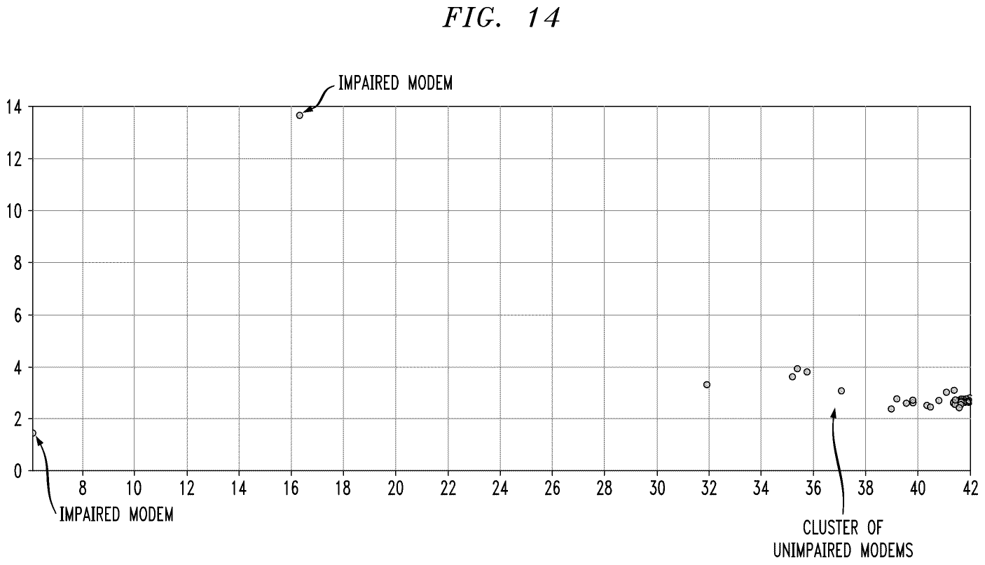

Data gathered and/or aggregated by the data collector 5004 is forwarded to the remote machine learning engine 5008 (step 6036). The remote machine learning engine 5008 classifies the signature of the telemetry information, such as the RxMER reading (e.g., for each cable modem on every OFDM or OFMDA channel), and submits the results to the remote server 6016 (step 6040). The classification can be performed on a per-cable modem 4016, 4020, 5020 basis. In one or more exemplary embodiments, the remote machine learning engine 5008 is trained using telemetry information that has be annotated (labeled) (e.g., by a human subject matter expert) with the appropriate classification of the signal. The ML trainer is illustrated at 5005, indicating model training based on annotated data from data collector 5004 with the trained model output to the ML classifier 5008. The skilled artisan will have general familiarity with training machine learning (ML) systems and using the trained systems for inferencing, and with developing rules-based systems, using ML systems implemented in software on a general purpose computer, software on a special purpose computer (e.g., arrays of graphics processing units (GPUs), with a hardware accelerator, with non-Von Neumann machines, with specialized hardware, using backpropagation for training neural networks, and the like). Note that FIG. 13 is a non-limiting example of data on which engine 5008 can operate.

The remote server 6016 is, for example, a compute server that hosts the (trained) remote machine learning engine 5008, carries out the analysis, and stores the results in a suitable data store. In addition, the remote server 6016 works with the remote machine learning engine 5008 to process the classification results (step 6040) and identify network components, such as filters, diplexers and the like, which were implicated by the classification results (step 6044). For example, the existence of a diplexer in a cable modem 4016 can be identified and a determination made whether the utilization of the full bandwidth of the upstream spectrum is impaired. The results of the classification, the component identification, and any subsequent analysis is stored in a datastore, such as the database (step 6048). Step 6052 represents server 6016 contacting the operations block to initiate mitigation procedures.

Operations block 6020 is responsible for mitigating the impairment based on the classification results, the component identification, and subsequent analysis (performed by either the remote server 6016 or the operations 6020—in some cases, equipment problems can be mitigated with software such as PMA (remote server 6016); while sometimes it is necessary to carry our physical plant intervention via operations block 6020). Operations block 6020 represents a physical operations center with human operators, an automated mitigation operation center, or a mixture of both. The mitigation can be performed automatically (such as via a reconfiguration of a network component, either on-site or remotely via the cable network plant), manually by an on-site technician or other user (“truck roll”), or remotely by a technician or other user. For example, lists of customers having certain issues (such as a low-split, in-home amplifier) can be automatically generated, either by operations 6020 or as part of step 6044. In some cases, the operations unit 6020 can prevent an upgrade to a high-split service until a particular filter has been removed, can prevent channel bonding for high-split channels, and the like. In additional to manual intervention by a remote technician or person in operations block 6020, aspects such as preventing upgrade, preventing channel bonding, and so on can be automated. In some cases, instead of removal, a device can be remotely deactivated. Note that operations 6020 could in some cases prevent upgrade/prevent channel bonding by using ML. Generally, however, the filters that prevent upgrade because they are blocking part of the spectrum and/or prevent channel bonding will need to be found and removed manually, or else the services will need to be moved somewhere else in the spectrum to avoid using the part of the spectrum blocked by the filter. These filters typically cannot be remotely deactivated.

In another aspect, upstream and downstream signal services can in some cases be relocated into a different part of the spectrum to avoid interference, or via PMA, the modulation of the signal can be changed to something that will give a better result. This is preferable to truck rolls, where possible.

Based on classification by engine 5008, operations block 6020 can query the data store results for all network elements with a certain signature, such as that depicted in FIG. 13. FIG. 13 is an example signal waveform for an impaired cable modem 5020 (impairment is caused by other network equipment). The observed roll-off in the signal creates unusable spectrum 7008. Roll-off of the sub-carriers starts at 42 MHz and carriers become unusable/inactive above 62 MHz. Generally, impairments can be caused by, for example: (i) other equipment in the network, (ii) equipment external to the network (an LTE system is a non-limiting example—LTE interference is a different case to the roll-off case), or both. In the scenario depicted in FIG. 13, the waveform is the result of an in-home amplifier that, while being useful for low-split DOCSIS 3.0 technology (upstream path bandwidth of 5 MHz to 42 MHz; guard band of 42 MHz to 52 MHz; and downstream path bandwidth above 52 MHz), prevents DOCSIS 3.1/4.0 high-split services (upstream path bandwidth of 5 MHz to 204 MHz; guard band of 204 MHz to 258 MHz; and downstream path bandwidth above 258 MHz). Other potential impairments include FM impairments at 88-108 MHz, over-the-air television (OTA TV) broadcasts at 54 MHz to 216 MHz, water on the line which can create a “ripple” (which can occur at any frequency), and the like (e.g., OTA TV channels in the UHF (ultra high frequency) spectrum 470-608 MHz, cell phone operators operating LTE anywhere in the spectrum 400-2100 MHz, etc.).

The classifications provided by the remote machine learning engine 5008 for the signal of FIG. 13 can include an identification of an in-house amplifier, water in the cable, and the like. Operations unit 6020 can query the datastore for, for example, a list of customers having equipment characterized by a particular signature, a given configuration, a specified network impairment, and the like. It will thus be appreciated that many kinds of impairments can happen in a network, such as FM impairments above 88 MHz; over-the-air television broadcast impairments from 54-216 MHz (UHF spectrum 470-608 MHz); the aforementioned water in the line inducing a ripple; and the like. The ML engine 5008 can classify the impairments, determining that a signature looks like an amplifier in the house, water in the cable, and so on.

In some instances, the remote machine learning engine 5008 uses a rules-based analyzer that compares telemetry information, such as an RxMER reading, with the conditions of different rules, and classifies the candidate RxMER using the rule whose conditions match the candidate RxMER or most closely match the candidate RxMER.

FIG. 14 is an example graph showing the relationship of an average MER value (average (of all sub-carriers in the channel RxMER file for a single modem) MER value) and standard deviation of the MER value for each of a plurality of cable modems 4016, 4020, 5020, in accordance with an example embodiment (e.g., for a classifier identifying modems with filter or amplifier signatures). The x-axis represents the average MER value (where a higher value is considered better) and the y-axis represents the standard deviation of the MER value (of all sub-carriers in the channel RxMER file for a single modem, where a lower value is considered better). It is noted that a low MER value will prevent the successful upstream transmission of data. Thus, the cable modems 4016, 4020, 5020 corresponding to the lower right corner of the graph will exhibit proper operation over the full bandwidth of the high-split upstream channel as they exhibit a high MER value and a low standard deviation (a cluster of unimpaired modems). Each dot is a single modem within the OFDMA channel. Clusters of dots represents multiple modems with similar conditions (similar average MER and standard deviation MER values). A tight cluster indicates very similar conditions or degrees of impairment. The two remaining cable modems 4016, 4020, 5020 are impaired due to a low MER value or a high standard deviation (e.g., as in FIG. 13), and will not operate properly over the full bandwidth of the high-split upstream channel.

It is worth noting that one or more embodiments operate without the use of full band capture (FBC), which is a type of in-home spectrum analyzer capability, a cable modem spectrum analysis feature available in DOCSIS 3.0 and 3.1 cable modems. Cable modem spectrum analysis functionality was first defined in version 120 of the DOCSIS 3.0 Operations Support System Interface Specification (CM-SP-OSSIv3.0-120-121113) back in November 2012. It is worth noting that a significant issue with the use of FBC is that it reports only power levels (not MER), so unwanted impairments and noise under the signal are hidden by the signal. In contrast, using RxMER, the values are effectively signal-noise, which is the usable portion of the signal, at a sub-carrier resolution. Furthermore, one or more embodiments operate by scanning for inappropriate components without the use of direct addressing of inappropriate components (diplexers, filters, amplifiers, and the like).

Given the discussion thus far, it will be appreciated that, in general terms, an exemplary method, according to an aspect of the invention, includes the step of obtaining data from a plurality of first network components in a network. The data includes at least one detectable signature characterizing presence of at least one second network component that is incompatible with a modification of the network. Generally, a distinction can be made between the first network components that the data is obtained from (e.g., cable modem (CM), CMTS) and the “inappropriate” components (at least one second network component) such as filters, diplexers, and the like. One or more embodiments obtain data from the CM or CMTS, which is not necessarily the inappropriate component per se but which allows the system to infer presence of the inappropriate component. Of course, in some cases, data could be obtained from an inappropriate component such that the second network component(s) could overlap with the first network components.

A further step includes classifying the obtained data to identify the at least one detectable signature. Generally, impairments are caused by roll off/band stop created by inappropriate amplifiers, diplexers, splitters, and the like. The impairments themselves includes, e.g., loss of spectrum, the fact that some carriers do not get through, and the like. Still a further step includes identifying the at least one second network component implicated by the classification results. In a non-limiting example, a rules-based analyzer within the engine identifies a pattern that identifies an impairment which leads to the identification of what needs to be removed (e.g. filter, diplexer etc.). Yet a further step includes facilitating mitigation of the at least one second network component.

It is worth noting that in addition to presence of inappropriate amplifiers, diplexers, splitters, and the like, other problems can prevent a network change such as transition to high-split, such as presence of water, infiltration of FM/broadcast TV signals, ham radio, VHF, switched power supply noise, etc. These are relevant in one or more embodiments because the rules-based analyzer within the engine can identify a pattern that is associated with water and the impacted cable is then removed by a technician (water in the cable acts like a blocking filter; similarly, RF infiltration could be a shielding failure requiring replacement of a section of cable).

In one or more embodiments, the obtaining step is carried out with a data collector component in the network; the network includes a cable network (but could also be a fiber network or an RF network such as a cellular network); the classifying step is carried out with a machine learning engine; and the identifying step is carried out by a rules-based analyzer. In one or more embodiments, the rules-based analyzer (e.g., within the engine 5008) identifies a pattern that in turn identifies an impairment which leads to what needs to be removed—e.g. filter, diplexer, or the like.

In some instances, in the obtaining step, the modification includes migration from a first frequency split configuration of the cable network to a second frequency split configuration of the cable network. Generally, there can be a low-split to high-split migration, but aspects of the invention can also be generalized to other types of splits, because the same thinking applies to the many split options that DOCSIS 4.0 and future DOCSIS versions employ. For example DOCSIS 4.0 has split points at 204, 300, 396, and 482 MHz. Aspects of the invention can be employed as the industry transitions through all of the splits available; the last split becomes the low split and the next new standard split becomes the new high (er) split.

In one or more embodiments, the inappropriate network components include filters (e.g., MoCA, channel blocking, and the like), amplifiers, splitters, and diplexers (e.g., low split) that are compatible with the first frequency split configuration of the cable network but incompatible with the second frequency split configuration of the cable network.

In some cases, the facilitating of the mitigation includes messaging an operations center.

One or more embodiments further include carrying out the mitigation by having a human technician physically remove the at least one of the inappropriate network components based on instructions from the operations center. On the other hand, one or more embodiments further include carrying out the mitigation by having the operations center remotely deactivate the at least one of the inappropriate network components.

Some cases include, prior to carrying out the mitigation, having the operations center remotely prevent the migration as to a customer associated with the at least one of the inappropriate network components.

Some cases include, prior to carrying out the mitigation, having the operations center remotely prevent channel bonding for the migration as to a customer associated with the at least one of the inappropriate network components.

In some instances, in the obtaining step, the data includes received modulation error ratio (RxMER) measurements and the plurality of network components include cable modems. It is worth noting that it is possible to derive a poor network condition from modems that deliver empty RxMER files back to the ML process, because this indicates a channel issue, and an action can be taken based on that empty information. Stated differently, sometimes the pattern is that nothing is obtained back for any subcarriers-thus, generally, the data can be for any number of subcarriers including zero or more.

In some instances, in the classifying step, the at least one detectable signature includes standard deviation of the received modulation error ratio (RxMER) measurements exceeding a predetermined value.

In some instances, in the classifying step, the at least one detectable signature includes magnitude of the received modulation error ratio (RxMER) measurements being less than a predetermined value.

Generally, the skilled artisan can determine these predetermined values heuristically based on knowledge of the network and application. Note the impaired modems in FIG. 14—the skilled artisan can use heuristics to determine the predetermined values to identify impairments with too many false positives or false negatives.

In some cases, the cable modems are connected to a virtual cable modem termination system and the data collector component obtains the data from the cable modems by streaming telemetry from the virtual cable modem termination system (e.g., a v-CMTS in the cloud infrastructure is utilized with a transceiver in the field). On the other hand, in some cases, the cable modems are connected to a physical cable modem termination system and the data collector component obtains the data from the cable modems by simple network management protocol (SNMP) polling via the physical cable modem termination system.

In one or more embodiments, the obtaining step is carried out without the use of full band capture (FBC).

In one or more embodiments, the identifying of the at least one second network component is carried out without the use of direct addressing of the at least one second network component.

In some cases, the facilitating of the mitigation of the at least one second network component includes at least one of spectrum relocation and a modulation change, while leaving the at least one second network component in place.

It is worth noting that generally, changes in splits can be associated with downstream and/or upstream traffic.

In another aspect, an exemplary apparatus includes a memory, and at least one processor, coupled to the memory, and operative to carry out or otherwise facilitate any one, some, or all of the disclosed method steps. Furthermore, the at least one processor can be operative to instantiate any one, some, or all of the disclosed components, such as, for example, the data collector component in the network, the machine learning engine, and/or the rules-based analyzer.

In still another aspect, an exemplary apparatus includes: a cable network with a plurality of first network components and at least one second network component that is incompatible with a modification of the network; a data collector component in the cable network; a machine learning engine; and a rules-based analyzer. The data collector is configured to obtain data from the plurality of first network components in the network, the data including at least one detectable signature characterizing presence of the at least one second network component. The machine learning engine is configured to classify the obtained data to identify the at least one detectable signature. The rules-based analyzer is configured to identify the at least one second network component implicated by the classification results.

As noted, in some cases, the rules-based analyzer is included within the machine learning engine.

### System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

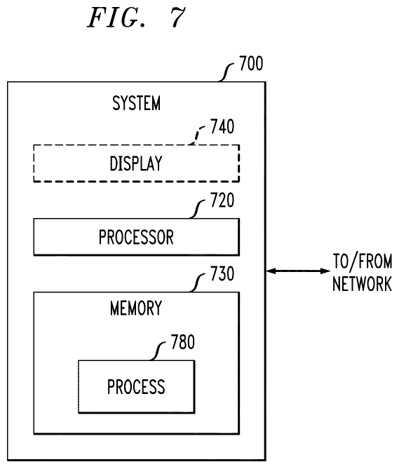

FIG. 7 is a block diagram of at least a portion of an exemplary system 700 that can be configured to implement at least some aspects of the invention, and is representative, for example, of one or more of the apparatuses, servers, or modules shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an application-specific integrated circuit (ASIC) or field-programmable gate array (FPGA) rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
obtaining data from a plurality of first network components in a network, the data including at least one detectable signature characterizing presence of at least one second network component that is incompatible with a modification of the network;
classifying the obtained data to identify the at least one detectable signature;
identifying the at least one second network component implicated by the classification results; and
facilitating mitigation of the at least one second network component.

2. The method of claim 1, wherein:
the obtaining step is carried out with a data collector component in the network;
the network comprises a cable network;
the classifying step is carried out with a machine learning engine; and
the identifying step is carried out by a rules-based analyzer.

3. The method of claim 2, wherein:
in the obtaining step, the modification comprises migration from a first frequency split configuration of the cable network to a second frequency split configuration of the cable network.

4. The method of claim 3, wherein the inappropriate network components include filters, amplifiers, splitters, and diplexers that are compatible with the first frequency split configuration of the cable network but incompatible with the second frequency split configuration of the cable network.

5. The method of claim 4, wherein the facilitating of the mitigation comprises messaging an operations center.

6. The method of claim 5, further comprising carrying out the mitigation by having a human technician physically remove the at least one of the inappropriate network components based on instructions from the operations center.

7. The method of claim 5, further comprising carrying out the mitigation by having the operations center remotely deactivate the at least one of the inappropriate network components.

8. The method of claim 5, further comprising, prior to carrying out the mitigation, having the operations center remotely prevent the migration as to a customer associated with the at least one of the inappropriate network components.

9. The method of claim 5, further comprising, prior to carrying out the mitigation, having the operations center remotely prevent channel bonding for the migration as to a customer associated with the at least one of the inappropriate network components.

10. The method of claim 2, wherein, in the obtaining step, the data includes received modulation error ratio (RxMER) measurements and the plurality of network components comprise cable modems.

11. The method of claim 10, wherein, in the classifying step, the at least one detectable signature comprises standard deviation of the received modulation error ratio (RxMER) measurements exceeding a predetermined value.

12. The method of claim 10, wherein, in the classifying step, the at least one detectable signature comprises magnitude of the received modulation error ratio (RxMER) measurements being less than a predetermined value.

13. The method of claim 10, wherein the cable modems are connected to a virtual cable modem termination system and the data collector component obtains the data from the cable modems by streaming telemetry from the virtual cable modem termination system.

14. The method of claim 10, wherein the cable modems are connected to a physical cable modem termination system and the data collector component obtains the data from the cable modems by simple network management protocol (SNMP) polling via the physical cable modem termination system.

15. The method of claim 2, wherein the obtaining step is carried out without the use of full band capture (FBC).

16. The method of claim 2, wherein the identifying of the at least one second network component is carried out without the use of direct addressing of the at least one second network component.

17. The method of claim 1, wherein the facilitating of the mitigation of the at least one second network component includes at least one of spectrum relocation and a modulation change, while leaving the at least one second network component in place.

18. A non-transitory computer readable medium comprising computer executable instructions which when executed by a computer cause the computer to perform the method of:
obtaining data from a plurality of first network components in a network, the data including at least one detectable signature characterizing presence of at least one second network component that is incompatible with a modification of the network;
classifying the obtained data to identify the at least one detectable signature;
identifying the at least one second network component implicated by the classification results; and
facilitating mitigation of the at least one second network component.

19. An apparatus comprising:
a memory; and
at least one processor, coupled to the memory, and operative to:
obtain data from a plurality of first network components in a network, the data including at least one detectable signature characterizing presence of at least one second network component that is incompatible with a modification of the network;
classify the obtained data to identify the at least one detectable signature;
identify the at least one second network component implicated by the classification results; and
facilitate mitigation of the at least one second network component.

20. The apparatus of claim 19, wherein:
the network comprises a cable network;
the at least one processor is further operative to instantiate:
a data collector component in the network,
a machine learning engine, and
a rules-based analyzer;
the obtaining step is carried out with the data collector component in the network;
the classifying step is carried out with the machine learning engine; and
the identifying step is carried out by the rules-based analyzer.

21. The apparatus of claim 20, wherein the modification comprises migration from a first frequency split configuration of the cable network to a second frequency split configuration of the cable network.

22. The apparatus of claim 21, wherein the inappropriate network components include filters, amplifiers, splitters, and diplexers that are compatible with the first frequency split configuration of the cable network but incompatible with the second frequency split configuration of the cable network.

23. An apparatus comprising:
a cable network with a plurality of first network components and at least one second network component that is incompatible with a modification of the network;
a data collector component in the cable network;
a machine learning engine; and
a rules-based analyzer;
wherein:
the data collector is configured to obtain data from the plurality of first network components in the network, the data including at least one detectable signature characterizing presence of the at least one second network component;
the machine learning engine is configured to classify the obtained data to identify the at least one detectable signature; and
the rules-based analyzer is configured to identify the at least one second network component implicated by the classification results.

24. The apparatus of claim 23, wherein the rules-based analyzer is included within the machine learning engine.
